(19) United States
(12) Patent Application Publication
(10) Pub. No.: US 2014/0183027 A1
(43) Pub. Date: Jul. 3, 2014

(54) INTERNAL HEAT EXCHANGER FOR DISTILLATION COLUMN

(71) Applicant: Mohamed Abouelhassan, Calgary (CA)

(72) Inventor: Mohamed Abouelhassan, Calgary (CA)

(73) Assignee: FLUOR TECHNOLOGIES CORPORATION, Aliso Viejo, CA (US)

(21) Appl. No.: 14/116,278

(22) PCT Filed: May 9, 2012
(86) PCT No.: PCT/US12/37128

§ 371 Date: Feb. 20, 2014

Related U.S. Application Data
(60) Provisional application No. 61/484,045, filed on May 9, 2011.

(51) Int. Cl. B01D 3/00

(52) U.S. Cl. CPC B01D 3/007
USPC 203/25

(57) ABSTRACT

Systems and methods are described for improving energy requirements of a distillation column. The distillation column can include one or more heat exchange surfaces within a middle section of the column, through which a cooling fluid can be fed to allow heat exchange of vapor rising within the distillation column.

This application claims the benefit of priority to U.S. provisional application having Ser. No. 61/484045 filed on May 9, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is heat exchangers, especially as they relate to distillation columns.

### BACKGROUND

In today's market, refining margins have been significantly diminished, capital investments are tight, and the need for energy efficiency is paramount. Complex distillation columns such as Crude and Vacuum columns, main fractionators in Delayed Coking Units, Hydrocracking Units, Fluidized Catalytic Cracking Units, and many others require the use of pump-arounds to remove heat from the column at different tray locations. A pump-around typically removes liquid from a distillation column, pumps the liquid through one or more heat exchangers, and then returns the cooled liquid to the column at the desired temperature.

A typical crude distillation unit 100 is shown in prior art FIG. 1, which includes four pump-arounds 110, 112, 114, 116 that each requires a chimney tray 120 to draw liquid, a pump-around pump 130, pump around exchangers 140, a flow control valve station, a liquid distributor for pump-around return 150, and a packed bed 160 inside the column 102. While the use of pump-arounds can allow for optimal removal of heat, pump-arounds disadvantageously increase the complexity and energy requirements of the columns, and add to their capital cost.

It is also known to use an internal tube bundle within a distillation column to supply or remove heat. This alternative is sometimes used for reboilers or condensers, but not as a replacement for pump-arounds.

Various other heat exchanger configurations are known in the art, e.g., WIPO publ. no. 2010/002611 to UOP LLC (publ. January 2010), U.S. Pat. No. 5,596,883 to Bernhard et al., U.S. Pat. No. 5,316,628 to Collin et al., WIPO publ. no. 00/70287 to Zeks Air Drier Corp. (publ. November 2000), EPO publ. no. 0952419 to Air Products and Chemicals, Inc. (publ. October 1999), U.S. Pat. No. 6,338,384 to Sakaue et al., U.S. Pat. No. 4,277,311 to Kwasnoski et al., and “Design of a heat-integrated distillation column based on a plate-fin heat exchanger”, Hugill et al., Proceeding of Sustainable (Bio)chemical Process Technology incorporating the 6th Int'l Conference on Process Intensification, Delft, The Netherlands, 27-29 September. However, such heat exchangers are insufficient to be used in place of a pump-around in a distillation column.

It has yet to be appreciated that energy requirements of a distillation column can be improved by utilizing internal heat exchangers in distillation columns sufficient to eliminate the need for the pump-arounds.

Thus, there is still a need for distillation columns that contain internal heat exchangers in the middle section of the columns that are sufficient to eliminate the need for one or more pump-arounds.

### SUMMARY OF THE INVENTION

The inventive subject matter provides apparatus, systems, and methods for improving energy requirements of a distillation column. A heat exchange surface can be provided within a middle section of the distillation column, which thereby eliminates the need for external pump-arounds. As used herein, the “middle section” of a distillation column means the section between, and excluding, the column's condenser in an upper section of the column and reboiler in a lower section of the column.

A cooling fluid can be fed through the heat exchange surface to thereby allow heat exchange of vapor rising within the distillation column. This advantageously eliminates the need for pump-arounds in the column, and thereby decreases the energy requirements of the distillation column.

In one aspect, contemplated distillation columns can include at least one heat exchanger disposed in a middle section of the distillation column. The at least one heat exchanger is preferably configured such that vapor within the heat exchanger rises by convection, and fluid with the heat exchanger falls by gravity. In such embodiments, the need for pumps can be eliminated to facilitate the heat exchange of fluids within the column. Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a prior art crude distillation unit.

FIG. 2 is a schematic of an embodiment of a distillation column having internal heat exchangers disposed in a middle section of the column.

FIG. 3 is a schematic of another embodiment of a distillation column having internal heat exchangers disposed in a middle section of the column.

FIGS. 4-5 are schematics of various embodiments of a heat exchanger.

FIG. 6 is a schematic of another embodiment of a heat exchanger

### DETAILED DESCRIPTION

One should appreciate that the disclosed techniques provide many advantageous technical effects including the simplification of complex distillation units such as Crude and Vacuum distillation units, the reduction of the capital cost and plot space required of distillation units by reducing the pump-around equipment requirements, and the achievement of higher energy efficiency by utilizing state of the art heat transfer technologies with very tight temperature approaches between the hot and cold sides.

Compared to the typical configuration of a pump-around, an internal heat exchangers disposed within the column allows for direct cooling of column vapor and liquid traffic through heat exchange across the plates or other components of the heat exchanger. The substitution of an internal heat exchanger for a pump-around eliminates the need for various components required by typical pump-arounds including, for example, a draw tray, a pump, an external heat exchanger, a control valve, and a liquid distributor.

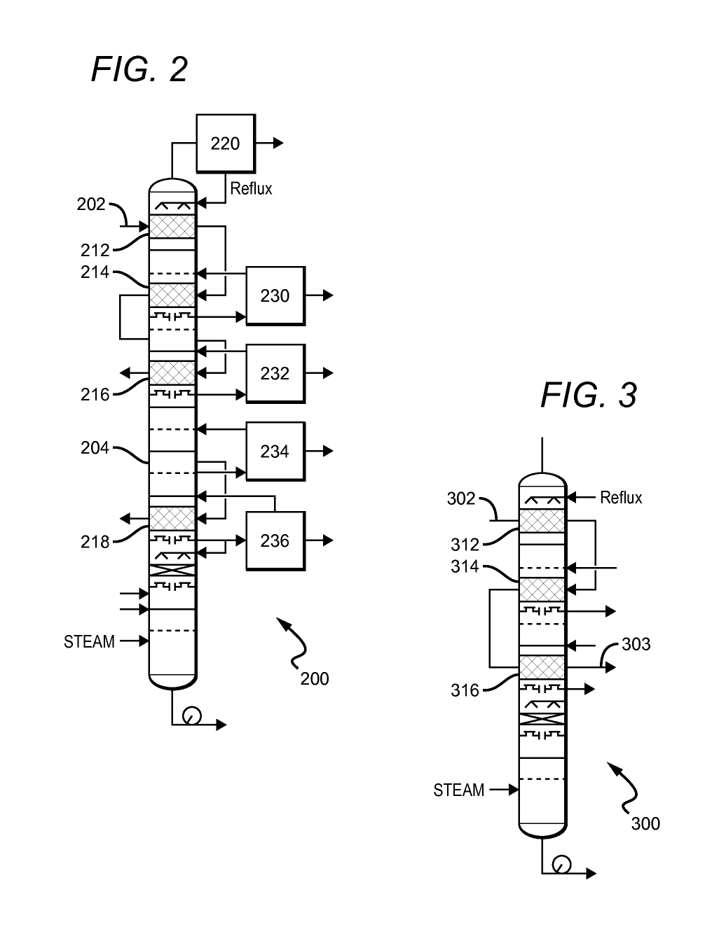

FIG. 2 illustrates a crude distillation unit 200 having internal heat exchangers 210, 212, and 214, and 216 disposed in a middle section of the unit 200 through which cooling fluid 202, 204 can respectively be fed. Although a single cooling fluid 202 is shown being fed to multiple heat exchangers 210, 212, 214, it is contemplated that each exchanger could have a distinct cooling fluid. It is also contemplated that a single cooling fluid 202 can be fed to all of the internal heat exchangers 210, 212, 214, 216. Although preferred columns include between one and five internal heat exchangers, it is also contemplated that the specific number of heat exchangers in the middle section of the distillation column could vary depending upon the size and dimension of the column, the fluids to be distilled, and so forth.

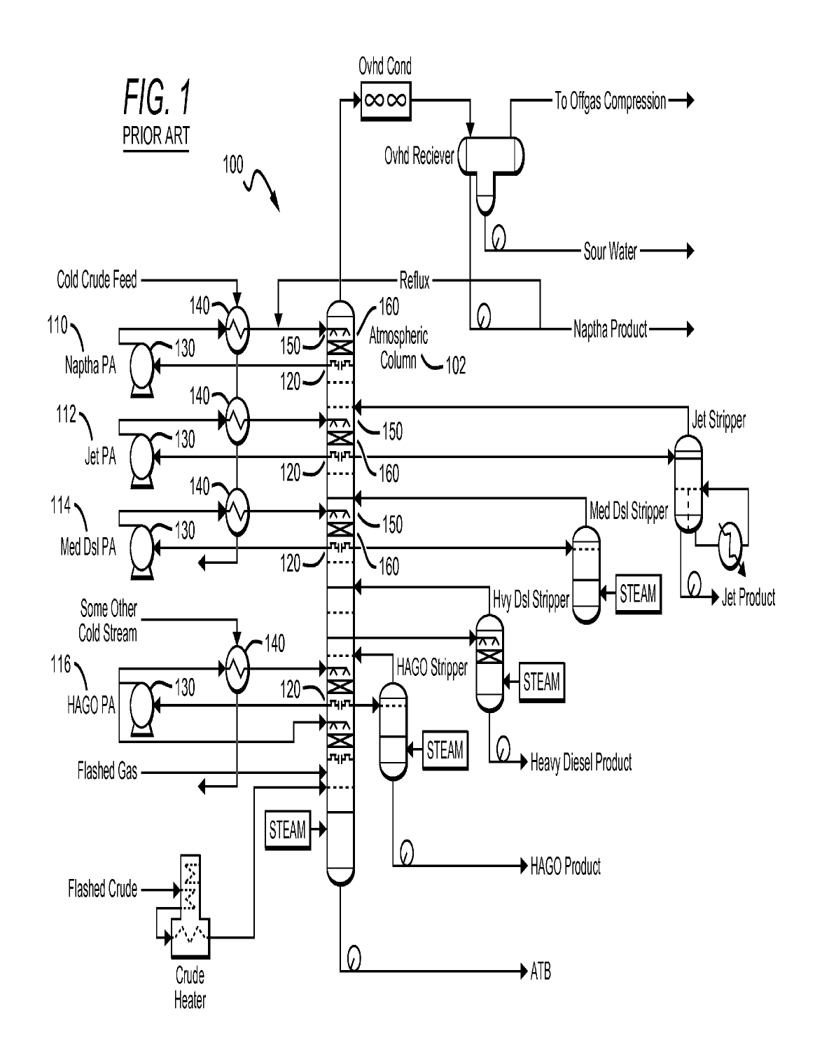

The heat exchangers 210, 212, 214, 216 can advantageously (a) replace a packed section between a typical pump-around draw and return, such as that shown in FIG. 1, and (b) perform both heat and mass transfer functions thereby eliminating the need for the pump-arounds. In especially preferred embodiments, the heat exchangers 210, 212, 214, 216 are each configured such that the column side of the plates resembles structured packing with very a high surface area and a low pressure drop, and the cooling side of the plates utilizes a standard plate heat exchanger configuration to achieve very high heat transfer coefficients and a tight temperature approach.

It is contemplated that each of the heat exchangers could have a distinct configuration from that of one or more of the other heat exchangers. Although plate and frame heat exchangers are preferred, it is contemplated that any commercially suitable configuration of a heat exchanger could be used, and that the specific type of exchanger may depend on the specific application.

The distillation unit 200 can further include one or more chimney trays or other components ion which fluid can be drawn from the unit 200 and fed to various strippers 230, 232, 234, and 236, where desired products can be produced. The distillation unit 200 can further include an overhead unit 220, which can include a condenser and a separator, and produce a reflux fluid that can be returned to unit 200.

In FIG. 3, another embodiment of a crude distillation unit 300 is shown having internal heat exchangers 310, 312, and 314 disposed in a middle section of the unit 300. A cooling fluid 302 can be fed sequentially through the heat exchangers 310, 312, and 314 to produce a heated cooling fluid 303. With respect to the remaining numerals in FIG. 3, the same considerations for like components with like numerals of FIG. 2 apply.

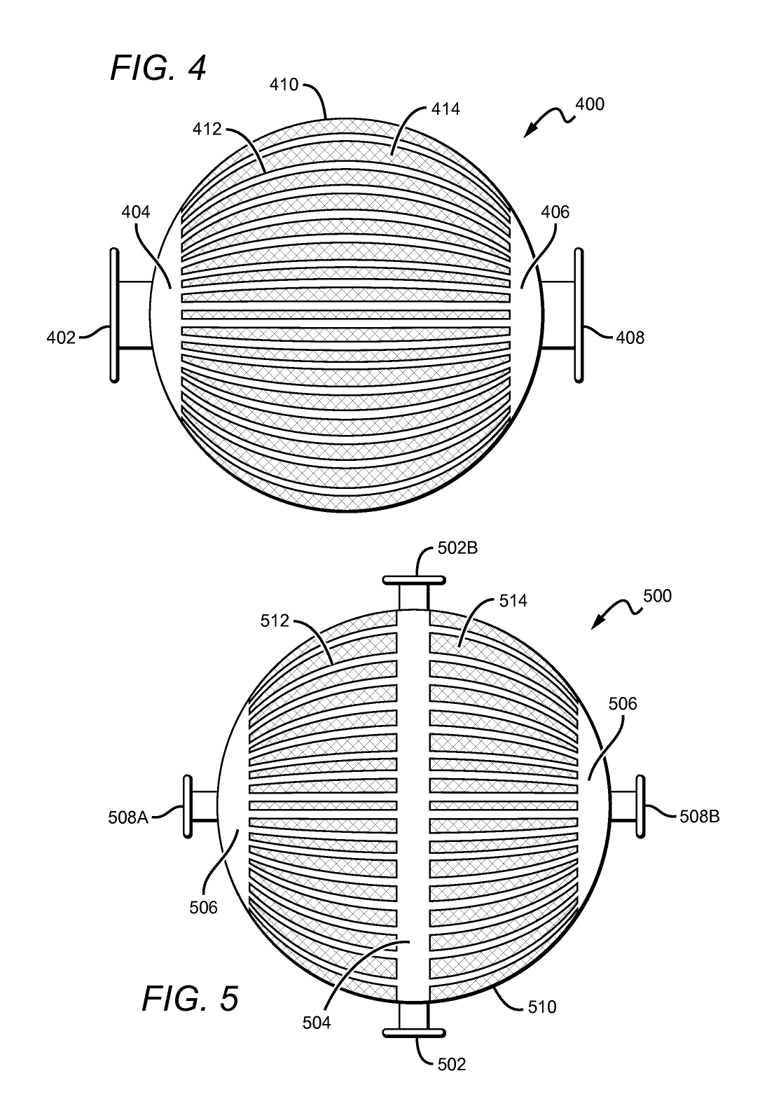

An exemplary embodiment of a column internal plate heat exchanger 400 is shown in FIG. 4. The heat exchanger 400 can include an inlet nozzle 402, which is preferably configured to receive an external cooling fluid. The inlet nozzle 402 can comprise any commercially suitable nozzle and configuration sufficient flow of a heat exchange fluid within the heat exchanger 400. The inlet nozzle can be fluidly coupled to an inlet head 404 to thereby distribute the heat exchange fluid within the heat exchanger 400.

The heat exchanger 400 can further include a series of plates 410, which each have a external and internal side 412, 414. The external side 412 of the plates 410 is preferably corrugated and/or finned to thereby increase the surface area of the external side. It is also preferred that the internal side 414 can include packing-like fins, which increase the surface area of the internal side of the plates 410 while providing for a low pressure drop of the fluid across the heat exchanger 400.

The heat exchange fluid flowing through inlet nozzle 402 can be collected via outlet head 406 and exit the heat exchanger 400 via outlet nozzle 408.

An alternative embodiment of a heat exchanger 500 is shown in FIG. 5, which includes first and second inlet nozzles 502A-502B coupled via inlet head 504 and first and second outlet nozzles 508A-508B, each of which includes an outlet head 506. With respect to the remaining numerals in FIG. 5, the same considerations for like components with like numerals of FIG. 4 apply.

It is further contemplated that the heat exchangers discussed herein could be used in various applications including, for example, complete distillation column system (including condenser and reboiler) in one shell, highly exothermic or endothermic reactors, and cryogenic processes.

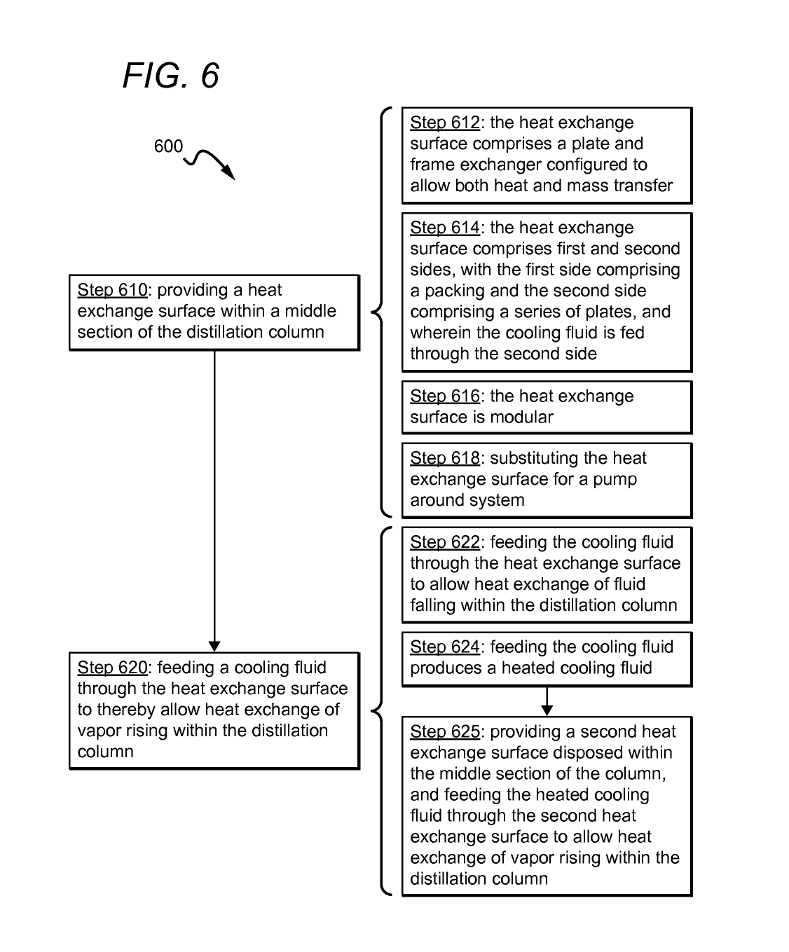

In FIG. 6, a method 600 for improving energy requirements of a distillation column is shown. The method 600 can include step 610 of providing a heat exchange surface within a middle section of the distillation column. Preferably, the heat exchange surface can be substituted for a pump-around system in step 618. In step 612, the heat exchange surface can comprise a plate and frame exchanger configured to allow both heat and mass transfer, although it is contemplated that any commercially suitable heat exchange surface could be used.

In other contemplated embodiments shown in step 614, the heat exchange surface can comprise first and second sides, where the first side has a packing and the second side has a series of plates. In such embodiments the cooling fluid is preferably fed through the series of plates, while the fluid to be cooled can be fed through the packing

In preferred embodiments shown in step 616, the heat exchange surface can be modular to thereby facilitate maintenance or replacement of the heat exchange surface, and allow the distillation column to be updated over time.

In step 620, a cooling fluid can be fed through the heat exchange surface to thereby allow heat exchange of vapor rising within the distillation column, and advantageously eliminate the need for an external pump-around. It is further contemplated in step 622 that the cooling fluid can be fed through the heat exchange surface to also allow for heat exchange of fluid falling within the distillation column. In such embodiments, the heat exchange surface can be used for heat exchange of vapor rising within the column via convection, and heat exchange of fluid falling within the column via gravity.

It is further contemplated in step 624 that the cooling fluid can be heated by the heat exchange contact with the hot fluids within the column to produce a heated cooling fluid. The heated cooling fluid can then be fed to a second heat exchange surface disposed within the middle section of the column in step 625 to further allow for additional heat exchange of vapor rising within the distillation column.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of improving energy requirements of a distillation column, comprising:
providing a heat exchange surface within a middle section of the distillation column; and
feeding a cooling fluid through the heat exchange surface to thereby allow heat exchange of vapor rising within the distillation column.

2. The method of claim 1, wherein the heat exchange surface comprises a plate and frame exchanger configured to allow both heat and mass transfer.

3. The method of claim 1, wherein the heat exchange surface comprises first and second sides, and wherein the first side comprises a packing and the second side comprises a series of plates, and wherein the cooling fluid is fed through the second side.

4. The method of claim 1, further comprising feeding the cooling fluid through the heat exchange surface to thereby allow heat exchange of fluid falling within the distillation column.

5. The method of claim 1, wherein the heat exchange surface is modular.

6. The method of claim 1, wherein the step of feeding the cooling fluid produces a heated cooling fluid, and further comprising providing a second heat exchange surface disposed within the middle section of the distillation column, and feeding the heated cooling fluid through the second heat exchange surface to thereby allow heat exchange of vapor rising within the distillation column.

7. The method of claim 1, wherein the step of providing the heat exchange surface comprises substituting the heat exchange surface for a pump around system.

8. An improved distillation column comprising at least one heat exchanger disposed in a middle section of the distillation column, and configured such that vapor within the heat exchanger rises by convection, and fluid with the heat exchanger falls by gravity.

9. The improved distillation column of claim 8, further comprising at least three heat exchangers, each of which is (a) disposed in a middle section of the distillation column, and (b) configured such that vapor within the heat exchanger rises by convection, and fluid with the heat exchanger falls by gravity.

10. The improved distillation column of claim 8, wherein the at least one heat exchanger comprises a plate and frame exchanger.

11. The improved distillation column of claim 10, wherein the plate and frame exchanger comprises a first fluid channel having packing and a second fluid channel comprising a series of plates.

12. The improved distillation column of claim 8, wherein the at least one heat exchanger comprises a modular unit.

13. The improved distillation column of claim 8, wherein the at least one heat exchanger is configured to receive an external cooling fluid.
